(19) United States
(12) Patent Application Publication
(10) Pub. No.: US 2002/0116251 A1
(43) Pub. Date: Aug. 22, 2002

(54) Method and apparatus for improving media service over multimedia network

(76) Inventors: Yen-Kuang Chen, Sunnyvale, CA (US); Matthew J. Holliman, Sunnyvale, CA (US); Rainer W. Lienhart, Santa Clara, CA (US); Minerva M. Yeung, Sunnyvale, CA (US)

Correspondence Address: John P. Ward, BLAKELY, SOKOLOFF, TAYLOR & ZAFMAN LLP, Seventh Floor, 12400 Wilshire Boulevard, Los Angeles, CA, 90025-1026, US

(21) Appl. No.: 09/876,769

(22) Filed: Jun. 6, 2001

Related U.S. Application Data
(60) Provisional application No. 60/270,398, filed on Feb. 20, 2001.

(51) Int. Cl. G06F 17/60

(52) U.S. Cl. 705/10

(57) ABSTRACT

A method to obtain a resource among nodes. In one embodiment, a first node receives an inquiry for a resource from a second node. The first node generates a cost evaluation of obtaining the resource and the first node transmits the cost evaluation to the second node for use in selecting where to obtain the resource.

### BACKGROUND

As the Internet becomes increasingly media-oriented, and particularly as media sharing becomes ever more popular amongst users, it has become important to address problems of sharing and distributing media over such a network.

In the current Internet architecture, an efficient way of acquiring a resource is often not well-defined. This is particularly true for the case of multimedia content, in which multiple versions often exist on the network and for which new versions can further be generated dynamically.

Delivery of contents/applications involves data movement, duplication, deletion, and transcoding. Efficient delivery should consider the characteristics of various resources (bandwidth, processing power, display, etc.). The fundamental process of the optimization of such deliveries could determine an effective use of resources on a distributed network of computing heterogeneous devices based on data characteristics (e.g. file size, compression bit rates, quality, etc.), application characteristics (security level, streaming vs. download support, etc.), network characteristics (available bandwidth, error rates, packet loss rates, connection speed etc.), and computing device capacity and capabilities (memory size, CPU speed, storage size, display, etc.).

Therefore there is a need to analyze and detect an optimal platform configuration for particular media operations at a particular instance. More specifically, there is a need to develop a cost-function analysis across a set of nodes to determine a reduced cost of obtaining a requested resource within the infrastructure.

### DESCRIPTION OF THE DRAWINGS

FIG. 1 illustrates a high-level view of one embodiment of a services application.

FIG. 2 illustrates the high-level details of one embodiment of the node-to-node daemon.

FIG. 3 illustrates a view from daemon when an application of a node makes a request.

FIG. 4 illustrates a diagram of calculating the cost of delivering a resource to node, according to one embodiment.

FIG. 5 illustrates a flow diagram of a daemon performing a cost evaluation of obtaining a requested resource, according to one embodiment.

FIG. 6 illustrates an example of performing a cost evaluation of obtaining a requested resource, according to one embodiment.

### DETAILED DESCRIPTION

A method and apparatus are described for utilizing a cost-function analysis across a set of nodes to dynamically reduce the cost of delivering data and/or resources (e.g., computation/Central Processing Unit (CPU) bandwidth, storage, etc.) requested throughout the set of nodes. The term “cost” as used herein includes a metric of the efficiency of an operation in a network (e.g., cost may correspond to or depend upon an aggregate throughput sustained by a network and/or latency associated with requests). The present invention is applicable to a variety of architectures, including peer-to-peer infrastructures such as Napster and Gnutella and media server farms in which clusters of machines are responsible for transcoding and delivering content to users. The present invention is also applicable to a network of heterogeneous devices.

First the following terms are defined, which are used throughout the description:

Resource (R): In one embodiment, a “resource” is a reference to data (e.g., an Moving Pictures Experts Group (MPEG) file). Note that there may be several semantically equivalent copies of the same content on a network, in different formats and thus syntactically distinct, each of which could correspond to the same resource R. In alternative embodiments, a resource is disk space or CPU cycles that could be the requested resource for distributed computing/NetBatch type applications.

Parameter constraints (P): When requesting a resource from the network, the requesting device/node is unlikely to be capable of viewing or handling all content types present on the network. Thus, in one embodiment, a requested resource has associated with it some set of constraints that the network satisfies when delivering the resource. Corresponding to the example of a resource R above, an example of a set Parameter of constraints is {video type: MPEG-4, maximum bitrate: 500 Kb/s, maximum resolution: 352×240}.

Transport protocol (T): For many applications, Transmission Control Protocol (TCP) suffices as the protocol by which to obtain files from the network. This is the case in typical peer-to-peer networks, which are commonly predicated on a download-and-view paradigm. However, in some multimedia applications, real-time delivery is desirable or even required. Such capabilities require provisioning in the underlying architecture for other transport protocols, which are effectively a special case of a required constraint for the resource. Examples of transport protocols T include Hyper Text Transport Protocol (HTTP), TCP, Real time Transport Protocol/User Datagram Protocol RTP/UDP, and so forth.

In one embodiment, further described below, a user/node can request from a network a resource R, satisfying some set of parameter constraints P, to be sent via a transport protocol T. In an alternative embodiment, the resource could be requested specifying more or less requirements.

One embodiment of the present invention performs a cost analysis to determine a reduced cost of retrieving a requested resource that includes parameter constraints. In one embodiment, one or more of the following cost functions are used to perform the cost analysis.

Cost of transcoding: cₓ(R, Pₗ, Pⱼ) is the cost of a requesting node converting a version of R that satisfies an initial constraints Pⱼ to one that satisfies the requesting node's target constraints Pᵢ. When j=i, cₓ(R, Pᵢ, Pⱼ)=0.

Cost of retrieving: c(y, R, Pⱼ) is the cost of obtaining a version of the resource that satisfies the initial constraints Pⱼ from a Node N_{Y}. When y=x, then c(y, R, Pⱼ) is the cost of retrieving R of Pⱼ from the local storage of Node Nₓ.

Cost of transmission: cₜ(x, y, R, Pⱼ) is the cost of transmission from the Node N_{Y} to the local node Nₓ. N_{Y} represents some set of nodes known to the local node Nₓ. When x=y, cₜ(x, y, R, Pⱼ)=0. In one embodiment, the cost transmission could includes factors such as network bandwidth, the network condition (e.g., traffic levels) of a network connection used to send and/or receive the requested resource.

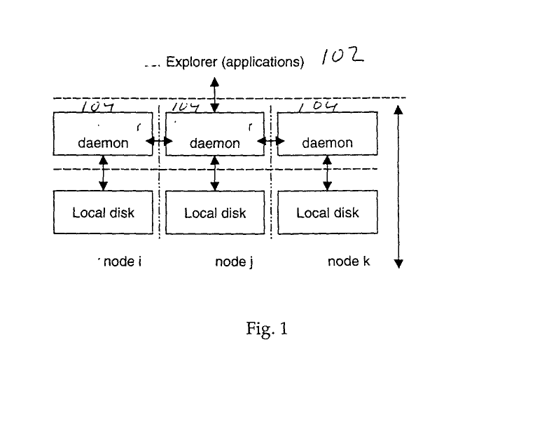

FIG. 1 illustrates a high-level view of one embodiment of a services application. As illustrated in FIG. 1, an Explorer 102 sends a request to its daemons 104 locally. In return, the pee daemons 104 communicate to each other and return the result via a cost-efficient way.

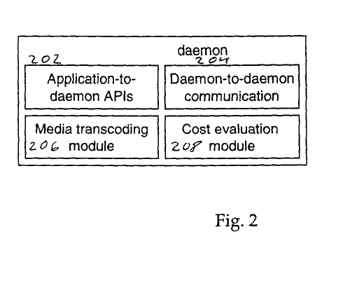

FIG. 2 illustrates the high-level details of one embodiment of the daemon. In one embodiment, there are four modules in a daemon: (1) an interface 202 that applications can use to talk to the daemon; (2) a module 204 that communicate between daemons; (3) a module 206 that can transcode media; and (4) a cost evaluation model 208. In alternative embodiment, more or less than all modules may be included in a daemon.

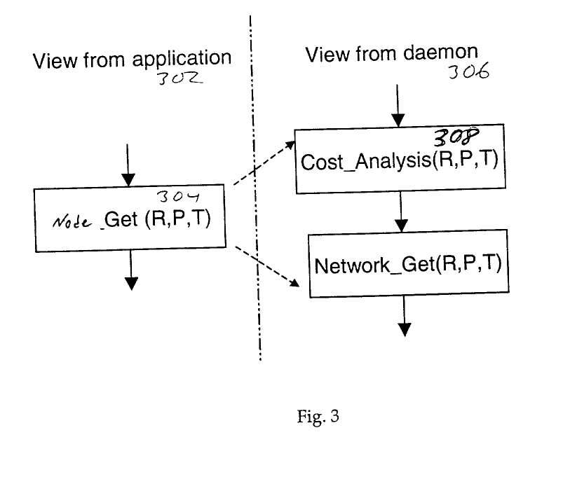

FIG. 3 illustrates a view from daemon when an application of a node makes a request. In one embodiment, there are two tasks in the daemon: first, the daemon analyzes the cost and then the daemon obtains the resource via the cost-efficient way in accordance with the cost analysis. In one embodiment, when an application 302 calls Get(R, P, T), the daemon 306 will establish both the reduced cost of retrieving a copy of the resource (i.e., compared to other available options of retrieving the resource) that satisfies the required constraints from the network, and the associated path by which content should be requested. In one embodiment, each node knows only the next node(s) in the path, and the cost of retrieving some resource from those nodes. The daemon executes the function Network_Get( ) 308 on the node associated with the minimum cost according to the cost analysis to request the resource.

In one embodiment, the cost analysis function is responsible for determining a cost of getting a requested resource locally and transcoding if necessary, cost of getting the resource from a node, and the cost of transmission. Based on the results, the daemon determines the best course of action to retrieve a resource (i.e., in view of available options) from the network satisfying some set of particular constraints.

In addition, the formulation is recursive. That is, the nodes in the network will calculate the minimal cost based on the feedback from other nodes.

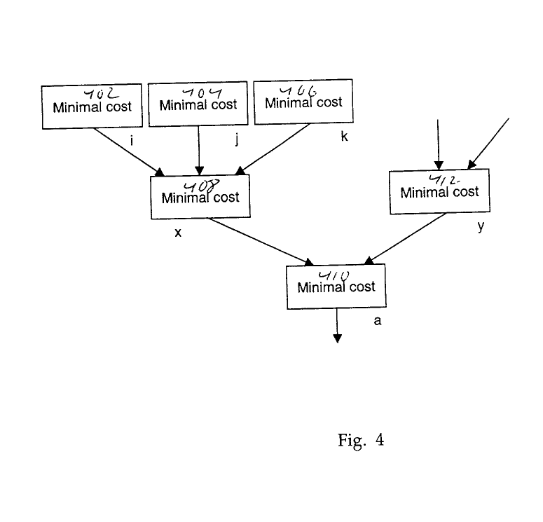

FIG. 4 illustrates a diagram of calculating the cost of delivering a resource to node 410. First, nodes i (402), j (404), and k (406) will return their best cost to node x (408). Then, node x (408) will return the best cost to a (410). After node a (410) receives the best cost from its nodes (408, 412), then node a (410) is able to decide the best route of delivery. In one embodiment, to speed up the response time, there is a limit on the number of recursive calculations. In another embodiment, a daemon-level timeout is set for trying to establish a remote reference to a requested resource.

Daemons on different nodes may invoke the same query on the same remote nodes multiple times. As a result, in one embodiment, an intelligent mechanism is included to reduce duplicate entries of the same resource in a result list generated when a node inquires about a resource. In particular, a node may use a cost-cache is used to store the previously calculated cost. An ID generated uniquely for each resource is used to keep track of the previously calculated cost for different resources. A node having a cost-cache checks its cache, when it receives a request for a cost analysis, to determine whether there has been a similar request recently. If there has been, the node can return the cached values instead of re-calculating everything.

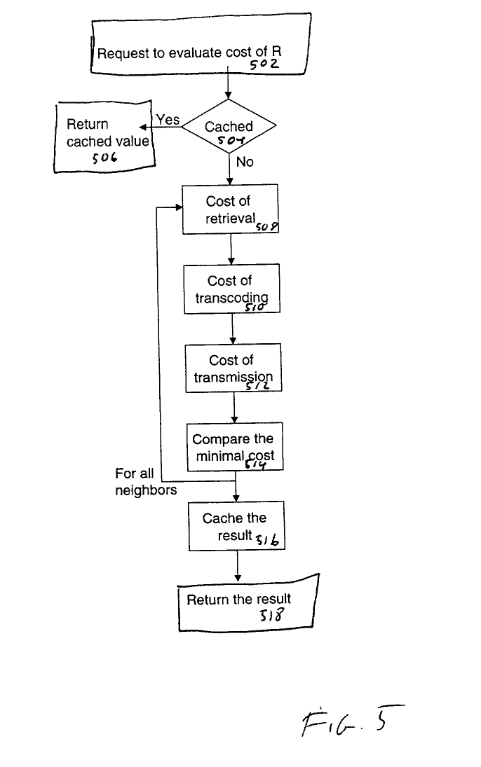

FIG. 5 illustrates a flow diagram of a daemon performing a cost evaluation of obtaining a requested resource. In block 502, the daemon receives the request to evaluate the cost of R. In decision block 504, the daemon determines whether it has previously cached a cost evaluation for R. If the node has the cost cached, in block 506 the cached value is returned to the requesting daemon.

If the node has not previously cached the cost, in block 508 the daemon determines the cost of retrieving R (which may include retrieving R from the node's respective local storage or retrieving it from a separate node). In block 510, the daemon determines the cost of transcoding R if necessary to meet the parameter constraints identified by the requesting node. In block 512, the daemon determines the cost of transmitting R from a separate node if necessary. In block 514, the daemon compares the cost of obtaining R from the available options (e.g., available nodes). Steps 508 through 514 are repeated for the neighboring nodes. In block 516, the results are optionally cached. In block 518, the results are returned to the node requesting the cost evaluation of obtaining R.

In one embodiment, the following cost analysis is used by the daemon to determine the minimum aggregate cost (i.e., in view of available options among nodes within the network) of obtaining a version of resource R satisfying some set of required constraints Pᵢ at a node N_{L}:

c(N_{L},R,Pₗ)=min min{c(Nₙ,R,P_{J})+Cₗ(N_{L},Nₙ,R,Pⱼ)+cₓ(R,P_{iiL ,P}ₗ)},

where c(Nₙ, R, Pⱼ) is the cost of Nₙ to obtain a version of the resource that satisfies the initial constraints P_{J} (whether it be from its local storage or from another node). cₜ(N_{L}, Nₙ, R, Pⱼ) is the cost of transmission from the node Nₙ to the local node N_{L}. cₓ(R, Pₗ, Pⱼ) is the cost of converting a version of R that satisfies some initial local constraints Pⱼ to one that satisfies the node's target constraints Pᵢ, at the local node N_{L}. For example, if Nₙ has a version of the resource that satisfies the target constraints Pⱼ, then the cost c(Nₙ, R, Pⱼ) can be as low as zero. However, if Nₙ does not have a version of the resource that satisfies the initial constraints P_{J}, then the cost c(Nₙ, R, Pⱼ) can include a transcoding cost at node Nₙ. The converting/transcoding cost cₓ(R, Pᵢ, Pⱼ) is zero when i=j because transcoding is not necessary. Furthermore, transcoding may occur at more then one node along a network path as content propagates to its destination.

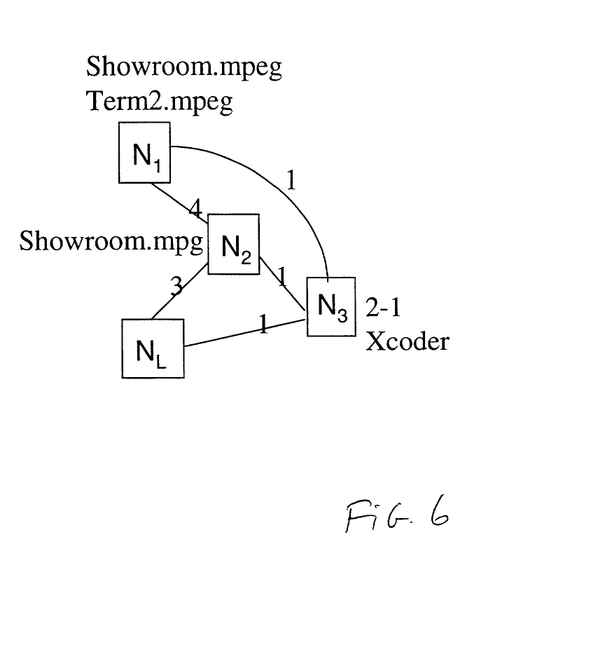

An example will assist in illustrating application of the cost analysis, according to one embodiment. In the example illustrated in network configuration of FIG. 6, node N_{L} is a wireless hand-held device. Node Nₗ has showroom.mpeg (MPEG-2) and term2.mpeg (MPEG-2). Node N₂ has a copy of showroom.mpg (MPEG-1). Node N₃ is a high-end node, which can transcode MPEG-2 sequences to MPEG-1 sequences, but without any media files at this moment. The numbers on the link are the cost of transmitting a file. The cost of transcoding from MPEG-2 to MPEG-1 on Node N₃ is 2. The cost of retrieving a file from all nodes is 1 (e.g., cost of retrieving from local storage).

Under the example, a user at Node N₁ request a file that is an MPEG-1 version of showroom.mpg at Node N_{L}. That is, R=showroom.mpg and P₁={MPEG-1}. In response, the Explorer/application at N_{L} calls the function Resource::EstimateCost(showroom.mpg, {MPEG-1}) in order to determine a minimum cost of obtaining the requested resource. The daemon in response performs the following functions to determine the minimum cost:

(a) Get resource local: C(N_{L},R,Pₗ)=infinite

(b) Get resource from node N₂: The total cost is 4 because C(N₂,R,P_{I})=1, Cₓ(R,Pₗ,Pₗ)=0, and Cₗ(N₁,N₂,R,P₁)=3. (C(N₂,R,P₁)=1 because there is a copy of R,P₁ locally at N₂.

(c) Get resource from node N₃: The total cost is 3 because C(N₃,R,P₁)=2, Cₓ(R,P₁,Pₗ)=0, and Cₜ(N_{L}, N₃,R,P₁)=1, where C(N₃,R,P_{I})=2=min { C(N₁,R,P₂)+Cₜ(N₃,N₁,R,P₂)+Cₓ(R,P₁,P₂)=4, C(N₂,R,P₁)+Cₜ(N₃,N₂,R,P₁)+Cₓ(R,P₁,P₁)=2}.

As a result, the cost evaluation module of the daemon determines the best case in this example network configuration of FIG. 6 is to get the requested resource from node 3 who gets the file from node 2.

In alternative embodiments, the cost analysis function described above could be used to determine whether a requested resource is present in the network configuration. In an embodiment determining if the requested resource is present, the cost of transcoding and cost transmitting are not factored into the analysis.

In another embodiment, the local node contains all information about resources available on the local network and expected capabilities of other nodes. This information may be stored and available in a distributed fashion, or accessible from a group leader responsible for maintaining directory information). Then a user can explicitly assign a sequence of operations throughout the network, including multi-step processing over one or more nodes. This can be accomplished manually, e.g. in the context of an owner of several interoperating but incompatible devices who needs to transform data to share it between such devices, such as in the case of content arriving from a Digital Video (DV) camera, transcoded to MPEG-4 for network transport, to be played on an MPEG-1 or MPEG-2-compatible receiver. This can also be achieved by the application of the preceding problem formulation on the local host to establish the optimal path for a resource.

By treating transmission and transcoding operations as edges in a directed graph, and nodes as vertexes, computing the optimal sequence of operations corresponds precisely to solving the single-pair shortest-path problem. A single-source shortest-path approach such as Dijkstra's algorithm suffices.

The architecture and methods described above can be stored in the memory of a computer system (e.g., set top box, video recorders, etc.) as a set of instructions to be executed. In addition, the instructions to perform the method described above could alternatively be stored on other forms of machine-readable media, including magnetic and optical disks. For example, the method of the present invention could be stored on machine-readable media, such as magnetic disks or optical disks, which are accessible via a disk drive (or computer-readable medium drive). Further, the instructions can be downloaded into a computing device over a data network in a form of compiled and linked version. In addition, the recursive nature of the cost analysis suggests the use of dynamic programming-type approach in one embodiment.

Alternatively, the logic to perform the architecture and methods as discussed above, could be implemented in additional computer and/or machine readable media, such as discrete hardware components as large-scale integrated circuits (LSI's), application-specific integrated circuits (ASIC's), firmware such as electrically erasable programmable read-only memory (EEPROM's); and electrical, optical, acoustical and other forms of propagated signals (e.g., carrier waves, infrared signals, digital signals, etc.); etc.

Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. A method comprising:
A first node generating a cost evaluation of obtaining a resource;
The first node using the cost evaluation in selecting where to obtain the resource; and
The first node transmitting an inquiry for the resource to the chosen node.

2. The method of claim 1, further comprising:
The first node receiving an inquiry for the resource from a second node;
and
The first node transmitting the cost evaluation to the second node for use in selecting where to obtain the resource.

3. The method of claim 1, wherein the inquiry for the resource includes parameter constraints.

4. The method of claim 3, wherein the inquiry for the resource includes transport protocol.

5. The method of claim 3, wherein generating the cost evaluation includes generating a cost of transcoding the resource from a first parameter constraint to a second parameter constraint.

6. The method of claim 1, wherein generating the cost evaluation includes generating a cost of transmitting the resource.

7. The method of claim 1, wherein the cost evaluation is done by computing a single-path shortest path of a graph representing operation sequences and costs.

8. The method of claim 2, wherein the cost evaluation transmitted to the second node includes a cost of the first node obtaining the resource from a third node.

9. The method of claim 8, wherein generating the cost evaluation includes recursively generating a cost of obtaining the requested resource from separate nodes.

10. The method of claim 6, wherein generating the cost evaluation includes recursively generating a cost of obtaining the requested resource from separate nodes via dynamic programming.

11. The method of claim 1, wherein generating the cost evaluation includes a cost of obtaining the resource from the first node.

12. The method of claim 3, wherein the cost evaluation generated by the first node comprises:
c(N_{L},R,Pᵢ)=min min{c(Nₙ,R,Pᵢ)+cₗ(N_{L},Nₙ,R,Pⱼ)+cₓ(R,Pᵢ,Pⱼ)}, wherein c(Nₙ, R, Pⱼ) is a cost of the first node obtaining the requested resource of an initial parameter constraint Pⱼ, cₜ(N_{L}, Nₙ, R, Pⱼ) is a cost of transmitting the resource from a separate node, and cₓ(R, Pᵢ, Pⱼ) is a cost of the second node converting the requested resource from an initial parameter constraint Pⱼ to a target parameter constraint Pᵢ.

13. The method of claim 11 wherein a daemon at the first node includes an application interface module, a media transcoding module, a cost evaluation module, and a daemon to daemon communication module.

14. The method of claim 1, further including the first node determining a path to obtain the requested resource from a third node.

15. The method of claim 9, wherein the cost evaluation transmitted to the second node is a cached result stored by the first node from a previous inquiry for the resource.

16. The method of claim 1, wherein generating the cost evaluation includes determining if the requested resource is present in a network, without considering a cost of transcoding the resource and a cost of transmitting the resource.

17. A machine readable medium having stored thereon a set of instructions, which when executed cause a node to perform a method comprising:
A first node receiving an inquiry for a resource from a second node;
The first node generating a cost evaluation of obtaining the resource; and
The first node transmitting the cost evaluation to the second node for use in selecting where to obtain the resource.

18. The machine readable medium of claim 17, wherein the inquiry for the resource includes parameter constraints.

19. The machine readable medium of claim 18, wherein the inquiry for the resource includes transport protocol.

20. The machine readable medium of claim 18, wherein generating the cost evaluation includes generating a cost of transcoding the resource from a first parameter constraint to a second parameter constraint.

21. The machine readable medium of claim 20, wherein generating the cost evaluation includes generating a cost of transmitting the resource.

22. The machine readable medium of claim 17, wherein the cost evaluation transmitted to the second node includes a cost of the first node obtaining the resource from a third node.

23. The machine readable medium of claim 22, wherein generating the cost evaluation includes recursively generating a cost of obtaining the requested resource from separate nodes.

24. The machine readable medium of claim 22, wherein generating the cost evaluation includes recursively generating a cost of obtaining the requested resource from separate nodes via dynamic programming.

25. The machine readable medium of claim 17, wherein generating the cost evaluation includes a cost of obtaining the resource from the first node.

26. The machine readable medium of claim 18, wherein the cost evaluation generated by the first node comprises:
c(N_{L},R,Pⱼ)=min min {c(Nₙ, R,Pⱼ)+cᵢ(N_{L},Nₙ,R,Pⱼ)+cⱼ(R,Pᵢ,Pⱼ)}, wherein c(Nₙ, R, P_{J}) is a cost of the first node obtaining the requested resource of an initial parameter constraint Pⱼ, cₜ(N_{L}, Nₙ, R, Pⱼ) is a cost of transmitting the resource from a separate node, and cₓ(R, Pᵢ, Pⱼ) is a cost of the second node converting the requested resource from an initial parameter constraint Pⱼ to a target parameter constraint Pᵢ.

27. The machine readable medium of claim 26, wherein a daemon at the first node includes an application interface module, a media transcoding module, a cost evaluation module, and a daemon to daemon communication module.

28. The machine readable medium of claim 17, further including the first node determining a path to obtain the requested resource from a third node.

29. The machine readable medium of claim 24, wherein the cost evaluation transmitted to the second node is a cached result stored by the first node from a previous inquiry for the resource.

30. The machine readable medium of claim 17, wherein generating the cost evaluation includes determining if the requested resource is present in a network, without considering a cost of transcoding the resource and a cost of transmitting the resource.

31. A method comprising:
A first node receiving an inquiry for a resource from a second node;
The first node generating a cost evaluation of obtaining the resource, the cost evaluation includes generating a cost of transcoding the resource from a first parameter constraint to a second parameter constraint, and a cost of transmitting the resource, wherein the cost evaluation generated by the first node comprises
c(N_{L},R,Pᵢ)=min min{c(Nₙ,R,Pⱼ)+cₜ(N_{L}, Nₙ,R,Pᵢ)+cₓ(R,Pᵢ,Pⱼ)}, wherein c(Nₙ, R, Pⱼ) is a cost of the first node obtaining the requested resource of an initial parameter constraint P_{J}, cₜ(N_{L}, Nₙ, R, Pⱼ) is a cost of transmitting the resource from a separate node, and cₓ(R, Pᵢ, Pⱼ) is a cost of the second node converting the requested resource from an initial parameter constraint Pⱼ to a target parameter constraint Pᵢ; and
The first node transmitting the cost evaluation to the second node for use in selecting where to obtain the resource.
